(19) United States
(12) Patent Application Publication
(10) Pub. No.: US 2024/0375293 A1
(43) Pub. Date: Nov. 14, 2024

(54) IN-CHAMBER MAINTENANCE APPARATUS, SYSTEM, AND MAINTENANCE METHOD USING THE SAME

(71) Applicant: Samsung Electronics Co., Ltd., Suwon-si (KR)

(72) Inventors: Jungjoon Park, Suwon-si (KR); Jongseong Ko, Suwon-si (KR); Daeyong Kim, Suwon-si (KR); Donghyun Kim, Suwon-si (KR); Jisu Kim, Suwon-si (KR); Pyungkang Kim, Suwon-si (KR); Kihong Park, Suwon-si (KR); Jungjun Park, Suwon-si (KR); Jooyoung Park, Suwon-si (KR); Junhyeok Park, Suwon-si (KR); Hoseok Song, Suwon-si (KR); Chiho Ahn, Suwon-si (KR); Kongwoo Lee, Suwon-si (KR); Hyunyoung Lee, Suwon-si (KR); Chuyoung Choung, Suwon-si (KR); Jeongmin Hwang, Suwon-si (KR)

(21) Appl. No.: 18/437,837

(22) Filed: Feb. 9, 2024

(30) Foreign Application Priority Data
May 10, 2023 (KR) 10-2023-0060461
Aug. 28, 2023 (KR) 10-2023-0113047

(51) Int. Cl. B25J 15/00; B25J 13/08

(52) U.S. Cl. CPC B25J 15/0028; B25J 13/089

(57) ABSTRACT

An in-chamber maintenance apparatus may include a stage module including a stage body in a chamber having a hollow interior, an XY stage mounted on an upper surface of the stage body and movable in an X-axis and a Y-axis direction perpendicular to each other, and a first driving portion configured to drive the XY stage, and a gripper module including a gripper body coupled to an upper surface of the XY stage, a gripping portion supported by the gripper body and configured to move up and down and rotate with respect to a Z-axis perpendicular to the X-axis and the Y-axis to be inserted into the hollow interior, and a second driving portion configured to drive the gripping portion.

### CROSS-REFERENCE TO RELATED APPLICATION

This application claims priority to and the benefit of Korean Patent Application No. 10-2023-0060461 filed in the Korean Intellectual Property Office on May 10, 2023, and Korean Patent Application No. 10-2023-0113047 filed in the Korean Intellectual Property Office on Aug. 28, 2023, the entire contents of which are incorporated herein by reference.

### BACKGROUND OF THE INVENTION

The present disclosure relates to an in-chamber maintenance apparatus, system, and a maintenance method using the same.

Among semiconductor processes, etching is a process in which a circuit pattern is etched on a wafer by injecting a reaction gas required for the process into a vacuum chamber and generating plasma. At this time, etching occurs on other parts in the chamber or deposits accumulate in the chamber, and to prevent deterioration in process quality, regular maintenance work (i.e., preventive maintenance; PM) such as replacement of consumables in the chamber, cleaning, and inspection of parts, etc., is performed.

In particular, precise concentric alignment and spacing control are required when assembling parts (focus ring, quartz ring, etc.) around the electrostatic chuck (ESC) in the chamber, and care must be taken to avoid damaging the object in the above work.

Recently, mobile robots have been developed to automate various maintenance tasks, but mobile robots inevitably generate cumulative errors due to the operation of multiple driving parts, so mobile robots are not easily utilized in processes that require a precision work such as semiconductor processing.

### SUMMARY OF THE INVENTION

The present disclosure provides an in-chamber maintenance apparatus, system, and a maintenance method using the same capable of performing precision work within a chamber through a stage module and a gripper module capable of precision operation and capable of performing various works according to the structure of a working portion of a replaceable gripper module.

An in-chamber maintenance apparatus may include a stage module including a stage body in a chamber having a hollow interior, an XY stage on an upper surface of the stage body and movable in an X-axis and a Y-axis direction perpendicular to each other, and a first driving portion configured to drive the XY stage, and a gripper module including a gripper body coupled to an upper surface of the XY stage, a gripping portion supported by the gripper body and configured to move up and down and rotate with respect to a Z-axis perpendicular to the X-axis and the Y-axis to be inserted into the hollow interior, and a second driving portion configured to drive the gripping portion.

An in-chamber maintenance apparatus may include a stage module including a stage body in a chamber having an opening and having a hollow interior, an XY stage on an upper surface of the stage body and movable in an X-axis and a Y-axis direction perpendicular to each other, and a first driving portion configured to drive the XY stage, a gripper module including a gripper body coupled to an upper surface of the XY stage, a gripping portion supported by the gripper body and configured to move up and down and rotate with respect to a Z-axis perpendicular to the X-axis and the Y-axis and to be received in the hollow interior, and a second driving portion configured to drive the gripping portion, and a manipulator coupled to an upper surface of the gripper module and configured to move the gripper module.

According to some embodiments, by using an in-chamber maintenance apparatus including a stage module and a gripper module capable of precision operation, precision work within a chamber may be automated by minimizing accumulation of errors of various driving portions according to conventional automation facility.

### BRIEF DESCRIPTION OF THE DRAWINGS

FIG. 1A is a drawing showing an in-chamber maintenance apparatus according to some embodiments.

FIG. 1B is a block diagram for explaining a configuration of an in-chamber maintenance apparatus according to some embodiments.

FIG. 2 is a drawing for explaining an in-chamber maintenance apparatus according to some embodiments.

FIG. 3A is a drawing for explaining an in-chamber maintenance apparatus according to some embodiments.

FIG. 3B is a drawing for explaining an in-chamber maintenance apparatus according to some embodiments.

FIG. 4A is a drawing showing a gripper module of an in-chamber maintenance apparatus according to some embodiments.

FIG. 4B is a drawing showing a gripper module of an in-chamber maintenance apparatus according to some embodiments.

FIG. 5 is a drawing showing an in-chamber maintenance apparatus according to some embodiments.

FIG. 6A is a drawing for explaining an operation process of a gripper module of an in-chamber maintenance apparatus according to some embodiments.

FIG. 6B is a drawing for explaining an operation process of a gripper module of an in-chamber maintenance apparatus according to some embodiments.

FIG. 7A is a drawing showing an in-chamber maintenance apparatus according to some embodiments.

FIG. 7B is a block diagram for explaining a configuration of an in-chamber maintenance apparatus according to some embodiments.

FIG. 8 is a drawing for explaining an in-chamber maintenance apparatus according to some embodiments.

FIG. 9 is a drawing showing a manipulator of an in-chamber maintenance apparatus according to some embodiments.

FIG. 10 is a flowchart for explaining a maintenance method using an in-chamber maintenance apparatus according to some embodiments.

FIG. 11A is a drawing showing a maintenance process using an in-chamber maintenance apparatus according to some embodiments.

FIG. 11B is a drawing showing a maintenance process using an in-chamber maintenance apparatus according to some embodiments.

FIG. 11C is a drawing showing a maintenance process using an in-chamber maintenance apparatus according to some embodiments.

FIG. 11D is a drawing showing a maintenance process using an in-chamber maintenance apparatus according to some embodiments.

FIG. 11E is a drawing showing a maintenance process using an in-chamber maintenance apparatus according to some embodiments.

### DETAILED DESCRIPTION

The present disclosure will be described more fully hereinafter with reference to the accompanying drawings, in which example embodiments of the disclosure are shown. As those skilled in the art would realize, the described embodiments may be modified in various different ways, all without departing from the spirit or scope of the present disclosure.

The drawings and description are to be regarded as illustrative in nature and not restrictive. Like reference numerals designate like elements throughout the specification.

Further, since sizes and thicknesses of constituent members shown in the accompanying drawings may be arbitrarily given for better understanding and ease of description, the present disclosure is not limited to the illustrated sizes and thicknesses. In the drawings, the thickness of layers, films, panels, regions, etc., may be exaggerated for clarity. For better understanding and ease of description, the thickness of some layers and areas may be exaggerated.

Throughout this specification and the claims that follow, when it is described that an element is “coupled/connected” to another element, the element may be “directly coupled/connected” to the other element or “indirectly coupled/connected” to the other element through a third element. In addition, unless explicitly described to the contrary, the word “comprise” and variations such as “comprises” or “comprising” will be understood to imply the inclusion of stated elements but not the exclusion of any other elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

Further, throughout the specification, the phrase “in a plan view” means when an object portion is viewed from above, and the phrase “in a cross-sectional view” means when a cross-section taken by vertically cutting an object portion is viewed from the side.

Hereinafter, an in-chamber maintenance apparatus 1 according to some embodiments, and a maintenance method using the same of the present disclosure will be described in detail with reference to the drawings.

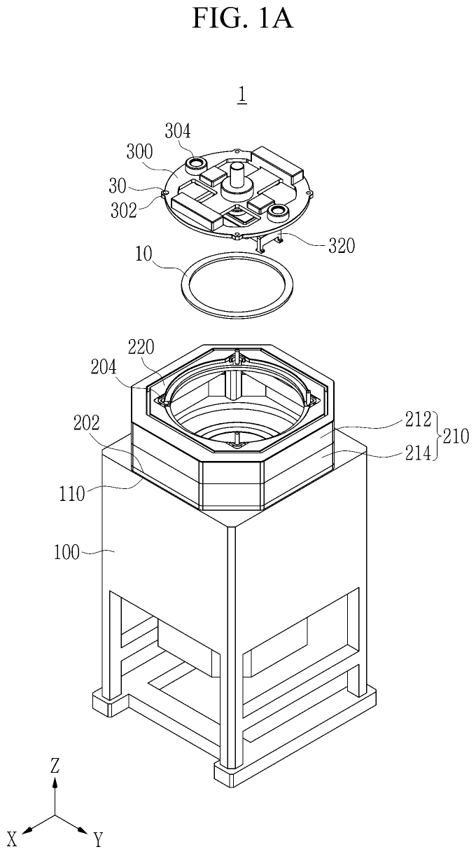

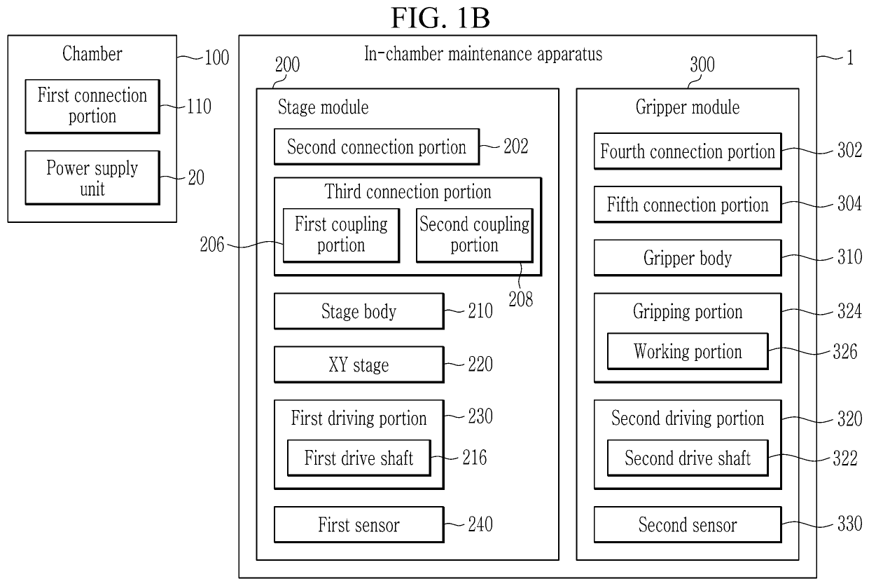

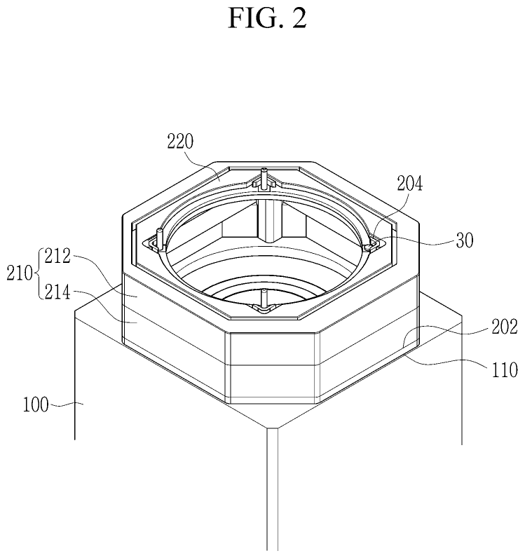

FIG. 1A is a drawing showing the in-chamber maintenance apparatus 1 according to some embodiments. FIG. 1B is a block diagram for explaining a configuration of the in-chamber maintenance apparatus 1 according to some embodiments. FIG. 2 is a drawing for explaining the in-chamber maintenance apparatus 1 according to some embodiments, and shows a stage module or stage system 200 disposed in an upper portion of a chamber 100.

An object 10 of the present disclosure may be the target for the work within the chamber, and although illustrated as a ring shape in the drawing, it is not limited thereto, and may include any of various parts that may be the subject of the work.

Referring to FIG. 1A, FIG. 1B, and FIG. 2, the in-chamber maintenance apparatus 1 according to some embodiments may include the stage module 200 mounted on the upper portion of the chamber 100 and a gripper module or gripper system 300 mounted on an upper portion of the stage module 200 and configured to perform precision work on the object 10 within the chamber 100.

Specifically, it may include the stage module 200 that includes a stage body 210 disposed in the upper portion of the chamber 100 and having a hollow interior, an XY stage 220 mounted on an upper surface of the stage body 210 and movable in an X-axis and a Y-axis direction perpendicular to each other, and a first driving portion 230 configured to drive the XY stage 220.

In addition, it may include the gripper module 300 that includes a gripper body 310 coupled to an upper surface of the XY stage 220, a gripping portion 324 supported by the gripper body 310 to be capable of moving up and down and rotating with respect to a Z-axis perpendicular to the X-axis and the Y-axis and inserted into the hollow interior of the stage body 210, and a second driving portion 320 configured to drive the gripping portion 324.

As for connection structure of respective configurations, the stage body 210 may include a second connection portion 202 coupled to a first connection portion 110 of the upper portion of the chamber 100 at a lower end, and the XY stage 220 mounted on an inner side of an upper end circumference of the stage body 210 may include a third connection portion 204 at an upper end, so as to be connected to a fourth connection portion 30 disposed at a position corresponding to the third connection portion 204 at a lower end of the gripper body 310.

Depending on embodiments, the chamber 100 may receive power from a power supply unit or power supply 20 of the chamber 100 that supplies power to the chamber 100, and the stage module 200 and the gripper module 300 may receive power from the power supply unit 20 of the chamber 100.

At this time, the first connection portion 110 in the upper portion of the chamber 100, the second connection portion 202 at the lower end of the stage body 210, the third connection portion 204 of an upper end of the XY stage 220 may further include a power connection portion 30 for supplying power from the power supply unit 20 of the chamber 100.

The power connection portion 30 included in the third connection portion 204 may be as in FIG. 2, but the form of the power connection portion 30 is not limited thereto.

As an example, a position of the third connection portion 204 may be any position corresponding to the fourth connection portion 302 of the lower end of the gripper body 310, and the position of the power connection portion 30 may be different depending on the position of the third connection portion 204.

Respective connection portions of the present disclosure may include physical and mechanical connection structures for positioning and fixing of configuration and coupling, and simultaneously, may include a structure to supply or receive the utilities for driving through the connector. The utility may include power, signal, pneumatic pressure, and the like.

When performing the work, the stage module 200 is placed on the upper portion of the chamber 100 and performs the work by coupling the first connection portion 110 of the chamber 100 and the second connection portion 202 of the stage module 200, and when not performing the work, mounting and assembling/disassembling of the stage module 200 on the upper portion of the chamber 100 may be easily enabled. Accordingly, during the work and before and after the work, additional configuration such as a separate support is not required, thereby reducing an occupied space and thus it may be effective in utilizing space.

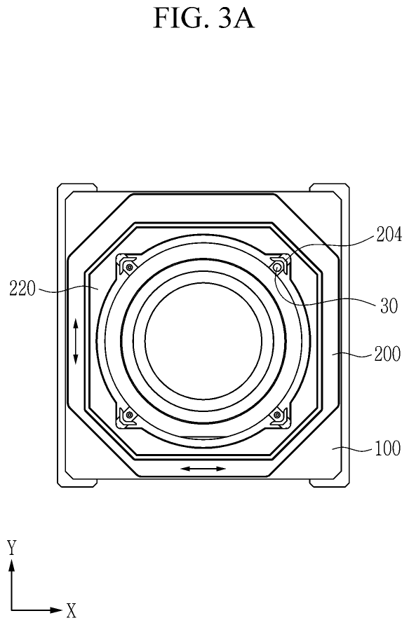

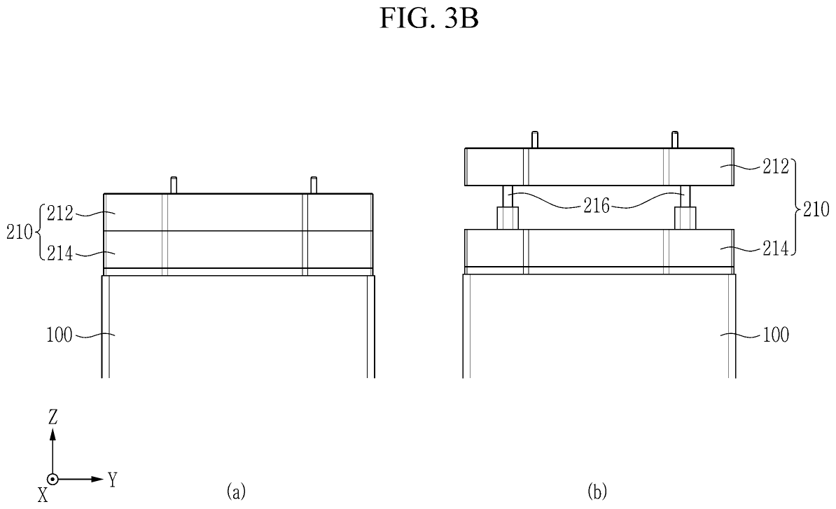

FIG. 3A is a drawing for explaining the in-chamber maintenance apparatus 1 according to some embodiments, and shows an appearance of the stage module 200 viewed from above. FIG. 3B is a drawing for explaining the in-chamber maintenance apparatus 1 according to some embodiments, and shows an appearance of the stage module 200 viewed from a side.

First, referring to FIG. 1A, FIG. 1B, FIG. 3A, and FIG. 3B, the first driving portion 230 of the stage module 200 includes a first drive shaft 216, and may include all driving elements for driving the stage module 200.

First, as shown in FIG. 3A, the first driving portion 230 may horizontally move the XY stage 220 in the X-axis and the Y-axis direction on an X-Y plane on which the XY stage 220 is disposed.

In the state that the stage module 200 is fixed to the chamber 100, the XY stage 220 may be driven for fine movement. Since principal parts within the chamber 100 mostly have the ring shape and are concentrically aligned around the electrostatic chuck (ESC), a large scaled movement is not required for the XY stage 220, in most cases.

As shown in FIG. 3A, according to some embodiments, the XY stage 220 may move in a diagonal direction, as well as the horizontal movement in up and down and left and right in the X-axis and the Y-axis direction on the X-Y plane.

Particularly, the first driving portion 230 of the stage module 200 is capable of precision operation, and for the precision operation, the stage module 200 may include a first sensor 240, which is a position measurement sensor configured to measure a position of the stage module 200.

The first sensor 240 may be a high-resolution sensor for precisely detecting the position, and may be capable of determining the position at a high precision by using the first sensor 240.

Although the position at which the first sensor 240 is disposed is not shown, any position capable of detecting position due to a fine movement of the stage module 200 and detecting the position during the process of coupling the stage module 200 and the chamber 100 and coupling the stage module 200 and the gripper module 300 may be such position without limitation.

The third connection portion 204 shown in FIG. 3A is an embodiment employing a positioning pin and a clamp for fixing, and includes the power connection portion 30.

However, the third connection portion 204 is not limited to the structure shown in the drawing, and although not shown in the drawings, in other embodiments, the third connection portion 204 may be in various structure that includes a first coupling portion 206 coupled to the fourth connection portion 302 of the gripper module 300 disposed at an upper end, and a second coupling portion 208 configured to guide coupling of the first coupling portion 206. The third connection portion 204 is coupled by being inserted into the recess of the fourth connection portion 302, and if the first coupling portion 206 is structured to protrude, the second coupling portion 208 may be structured to guide the path of the first coupling portion 206 to be inserted into the recess of the fourth connection portion 302.

As an example, the second coupling portion 208 may be structured to surround the first coupling portion 206 in order to fix a position of the first coupling portion 206, and may have a form that narrows as a distance to the fourth connection portion 302 becomes smaller. However, the first coupling portion 206 and the second coupling portion 208 are not limited to the form described above, but may be structured in any form such that, as for the first coupling portion 206 coupled to the fourth connection portion 302, insertion of the first coupling portion 206 into the coupling position of the fourth connection portion 302 may be facilitated.

As still another embodiment, the third connection portion 204 may have a kinematic coupling structure that has a coupling structure between a plurality of pins having a spherical or 3-dimensionly curved shape and a plurality of recesses corresponding thereto.

In addition, as shown in FIG. 3B, the first drive shaft 216 included in the first driving portion 230 of the stage module 200 may move the stage body 210 up and down along the Z-axis.

The stage module 200 includes one or more of the first drive shafts 216 disposed parallel to the Z-axis, on a circumference where a first stage body 212 disposed on an upper end and a second stage body 214 disposed on a lower end meet, and the first stage body 212 may move up and down in the Z-axis direction by the first drive shaft 216, so as to be separated from or coupled to the second stage body 214.

Although the gripper module 300 is not illustrated in FIG. 3A and FIG. 3B, the driving of the stage module 200, that is, the stage body 210 and the XY stage 220 is for precision assembling and disassembling work of the object 10 within the chamber 100, and may mean that, while being coupled to the gripper module 300, the XY stage 220 moves in the X-axis and the Y-axis direction or the first stage body 212 moves up and down.

In the case of automated robot apparatuses, when the automated robot directly performs the precision work, error accumulation frequently occurs in operation processes such as horizontal and vertical movement and operation of the robot arm, and it is difficult to force the automated robot to perform the precision assembly work on the parts within the chamber.

The in-chamber maintenance apparatus 1 according to present disclosure may only use the stage module 200, the gripper module 300, to complete performing the precision work within the chamber 100, and is meaningful in that error accumulation by the conventional automated robot is improved. A manipulator 400, which is an automated robot apparatus of the present disclosure, serves to transport or transfer the component part, the object 10, or the like, finished with the precision work, together with the gripper module 300, and is characterized that the effect error due to driving the manipulator 400 is substantially minimized with respect to the precision work.

That is, the manipulator 400 of the present disclosure is to transport or transfer the component parts and objects 10 to be assembled to or disassembled from the in-chamber maintenance apparatus 1 but not to directly perform the precision works, and the precision work is performed by the stage module 200 and the gripper module 300 within the in-chamber maintenance apparatus 1.

Resultantly, according to the present disclosure, as the precision work is performed within the stage module 200 by coupling the stage module 200 to the chamber 100, the primary effect of increasing the precision of the work may be obtained, and in particular, since the stage module 200 of the in-chamber maintenance apparatus 1 according to present disclosure is capable of precision operation, the secondary effect of increasing the precision of the work may be obtained.

As an example, whereas a work on the object 10 is performed by simply moving the working object to the required position along a rail in the conventional work apparatus, in the in-chamber maintenance apparatus 1 according to present disclosure, the XY stage 220 of the stage module 200 is capable of fine horizontal movement in the X and Y directions, and depending on embodiments, capable of fine rotation with respect to the Z-axis, and in addition, the first stage body 212 is capable of moving up and down in the Z-axis direction, by which the range of the driving error may be minimized by the stage module 200 capable of fine adjustment.

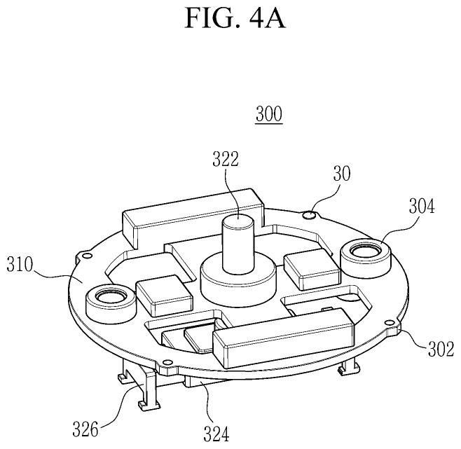

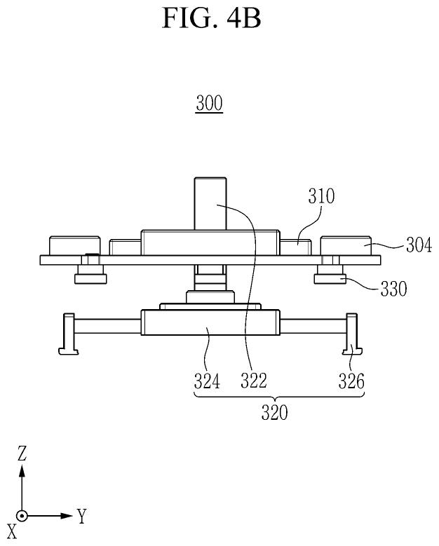

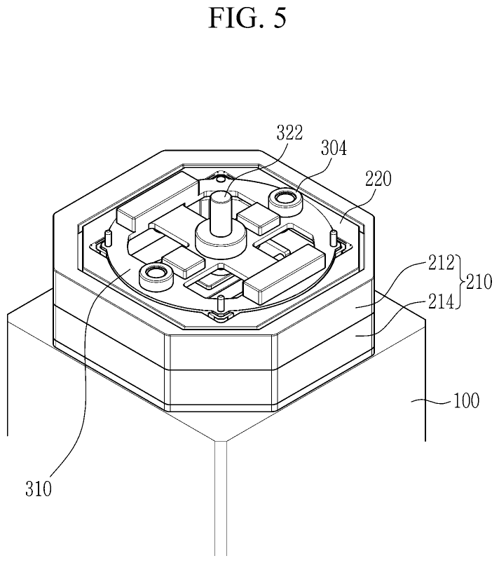

FIG. 4A and FIG. 4B are drawings showing the gripper module 300 of the in-chamber maintenance apparatus 1 according to some embodiments. FIG. 5 is a drawing showing the in-chamber maintenance apparatus 1 according to some embodiments, and shows the configuration in which the gripper module 300 and the stage module 200 are coupled to each other.

Referring to FIG. 4A, FIG. 4B, and FIG. 5, first, the gripper module 300 may include the gripping portion 324 including the gripper body 310 disposed on an upper end of the stage module 200 and a working portion 326 disposed in a lower portion of the gripper body 310 and configured to perform a work on the object 10, and the second driving portion 320 penetrating the gripper body 310 and including a second drive shaft 322 connected to the gripping portion 324 and configured to drive the gripping portion 324 at a lower end.

The gripper body 310 is disposed on and coupled to the upper end of the XY stage 220, and may include, at the lower end of the gripper body 310, the fourth connection portion 302 coupled to the third connection portion 204 disposed on the upper end of the XY stage 220.

The fourth connection portion 302 may be positioned at a position corresponding to the position of the third connection portion 204 disposed on the upper end of the XY stage 220, and its position may be determined according to the position of the third connection portion 204.

In addition, as have been described above, a power connection portion configured to supply power from the power supply unit 20 of the chamber 100 to the gripper module 300 may also be included in the fourth connection portion 302.

As a connection structure for moving the gripper module 300, a fifth connection portion 304 may be included on an upper surface of the gripper body 310. The fifth connection portion 304 is a coupling configuration for coupling to the moving apparatus, during the process of moving the gripper module 300 before and after the maintenance work within the chamber 100.

The fifth connection portion 304 may have the illustrated form as a mere example, and it may be structured such that, through coupling of the fifth connection portion 304 of the gripper module 300 and the above moving apparatus, the worker may manually move the gripper module, or coupling to other transport robots (e.g., the manipulator) is enabled.

The gripping portion 324 is positioned in the lower portion of the gripper body 310, and may be connected to a lower end of the second drive shaft 322 extended in the Z-axis direction connecting the gripper body 310 and the gripping portion 324. The second drive shaft 322 may be extended in the Z-axis to support the gripping portion 324, and driven to move up and down and rotated with respect to the Z-axis.

The gripping portion 324 may include two or more working portions 326 (e.g., first and second working portions) extending in a direction parallel to the X-Y plane on which the XY stage 220 is disposed, and the working portion 326 has an adjustable length in the extending direction.

The adjustment through the gripping portion 324 and the working portion 326 provides merits of facilitating lifting heavy objects 10 compared to the case of lifting the object 10 using the conventional lift pin or the like, and easier gripping.

The gripping portion 324 and the working portion 326 are structured to be capable of performing various precision works such as assembly, disassembly, and maintenance, as well as the work of gripping the object 10, and is not limited to the form shown in the drawings.

The gripper module 300 may include a second sensor 330 mounted on a lower surface of the gripper body 310, and the second sensor 330 may be a sensor configured to measure an interval between the gripper body 310 and objects disposed in the lower portion of the gripper body 310. The second sensor 330 may be at least one of a vision sensor and a displacement sensor.

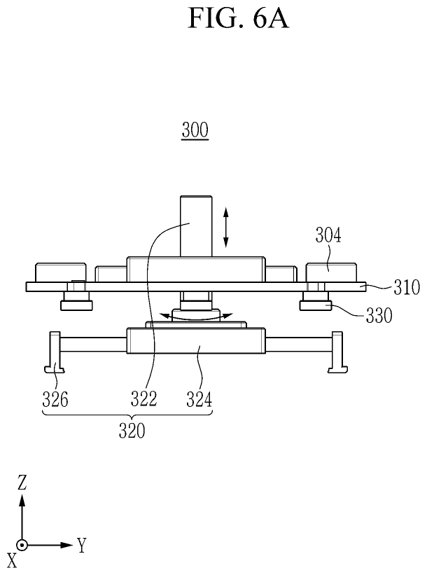

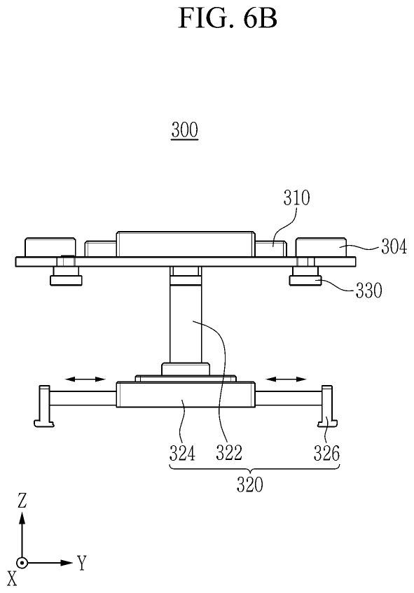

The operation process of the gripper module 300 will be described with reference to FIG. 6A and FIG. 6B.

FIG. 6A and FIG. 6B are drawings for explaining the operation process of the gripper module 300 of the in-chamber maintenance apparatus 1 according to some embodiments.

Referring to FIG. 6A, the gripper module 300 includes the second drive shaft 322 extending along the Z-axis perpendicular to the X-axis and the Y-axis while penetrating the gripper body 310, and the second drive shaft 322 is capable of moving up and down and rotating, with respect to the Z-axis perpendicular to the X-axis and the Y-axis. The gripping portion 324 connected to the lower end of the second drive shaft 322 may rotate and move, together with and according to moving up and down and rotating of the second drive shaft 322.

In the state that the gripper module 300 is coupled to the stage module 200, as the gripping portion 324 is enabled to move up and down with respect to the Z-axis by driving the second driving portion 320, the position of the gripping portion 324 may be adjusted to be closer to or away from the object 10 disposed at the lower portion.

The gripping portion 324 includes two or more working portions 326 extended in a direction parallel to the X-Y plane on which the XY stage 220 is disposed, and as the gripping portion 324 can rotate with respect to the Z-axis, a direction of the working portion 326 may be adjusted to a direction that facilitates the work of the working portion 326 on the object 10 disposed at the lower portion.

Referring to FIG. 6B, the working portion 326 may have an adjustable length in the extending direction. Accordingly, there is a merit that the work may be performed on the object 10 of various sizes.

The working portion 326 described in FIG. 6A and FIG. 6B is structured to be capable of gripping and enabling assembling and disassembling work, but the structure of the working portion 326 of the in-chamber maintenance apparatus 1 of the present disclosure is not limited thereto.

The working portion 326 may be a multi-axis driving apparatus having a structure capable of performing precision works within the chamber 100, and accordingly, may be replaced with the working portion 326 capable of performing works such as coupling, disassembling, cleaning, inspection, measurement, as well as gripping.

Accordingly, as with the preventive maintenance (PM) work of the chamber 100, required works may be performed on all component parts within the chamber 100.

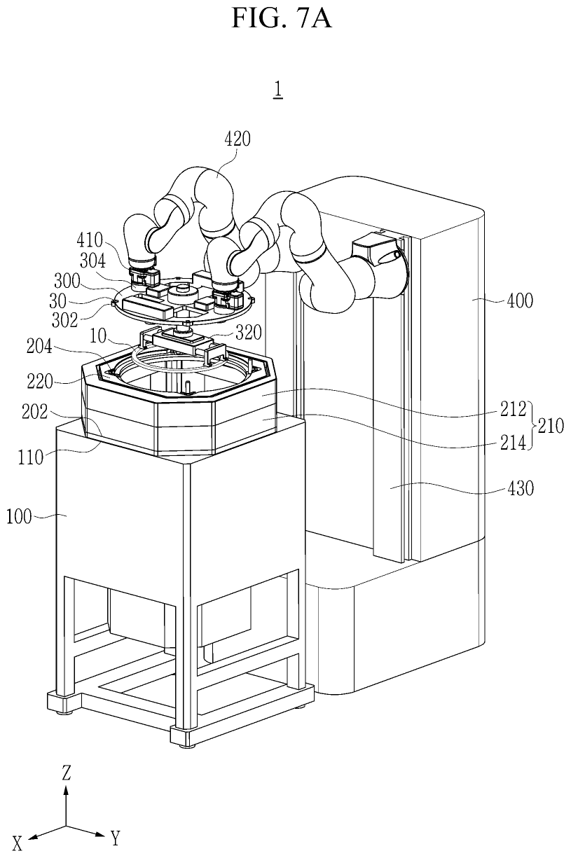

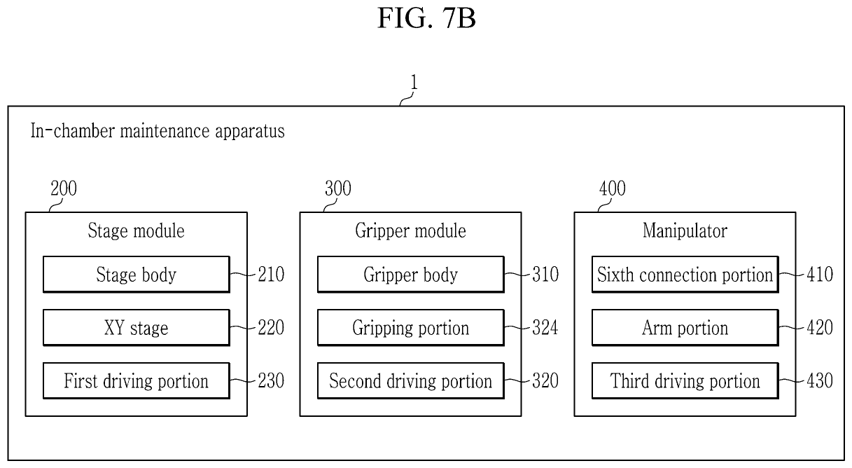

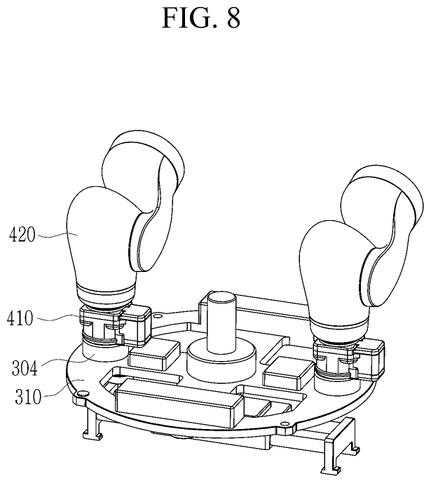

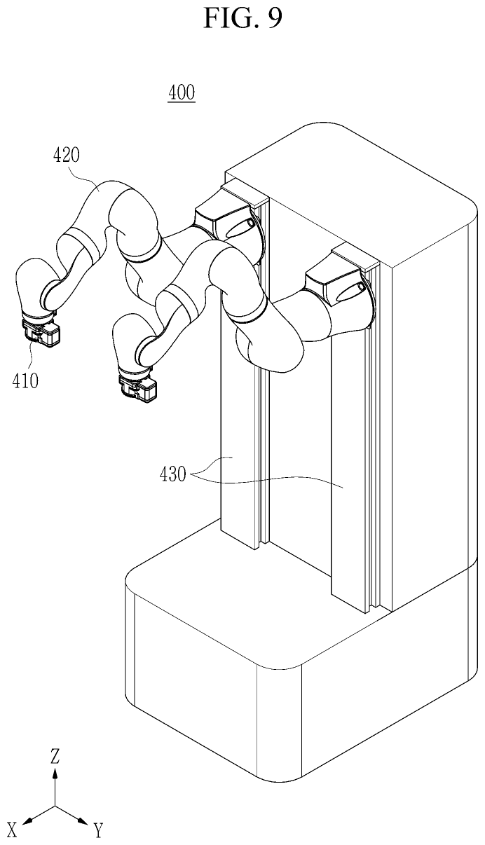

FIG. 7A is a drawing showing an in-chamber maintenance apparatus 1 according to some embodiments. FIG. 7B is a block diagram for explaining a configuration of an in-chamber maintenance apparatus 1 according to some embodiments. FIG. 8 is a drawing for explaining an in-chamber maintenance apparatus 1 according to some embodiments. FIG. 9 is a drawing showing the manipulator 400 of an in-chamber maintenance apparatus 1 according to some embodiments.

FIG. 7A shows an embodiment different from FIG. 1A, and shows the in-chamber maintenance apparatus 1 that includes the stage module 200 and the gripper module 300 of the in-chamber maintenance apparatus 1, and further includes the manipulator 400.

FIG. 7B illustrates the stage module 200 and the gripper module 300 as the configuration of the in-chamber maintenance apparatus 1, and the configuration of the in-chamber maintenance apparatus 1 including the stage module 200, the gripper module 300 is the same as the configuration of the in-chamber maintenance apparatus 1 of FIG. 1B.

Referring to FIG. 7A and FIG. 7B, the in-chamber maintenance apparatus 1 according to some embodiments may include a stage module 200 mounted on the upper portion of the chamber 100 and a gripper module 300 mounted on the upper portion of the stage module 200 and configured to perform precision work on the object 10 within the chamber 100, and a manipulator 400 coupled to an upper surface of the gripper module 300 and configured to move the gripper module 300.

Specifically, the stage module 200 may include the stage body 210 disposed in the chamber 100 having an opening and having the hollow interior, the XY stage 220 mounted on the upper surface of the stage body 210 and movable in the X-axis and the Y-axis direction perpendicular to each other, and the first driving portion 230 configured to drive the XY stage 220.

The gripper module 300 may include the gripper body 310 coupled to the upper surface of the XY stage 220, the gripping portion 324 supported by the gripper body 310 to be capable of moving up and down and rotating with respect to the Z-axis perpendicular to the X-axis and the Y-axis and inserted into the hollow interior, and the second driving portion 320 configured to drive the gripping portion 324.

The in-chamber maintenance apparatus 1 may further include the manipulator 400 coupled to the upper surface of the gripper module 300.

In particular, FIG. 8 illustrates coupling of the manipulator 400 to the gripper module 300, and the manipulator 400 may include a sixth connection portion 410 coupled to the fifth connection portion 304 of the upper surface of the gripper body 310.

In the gripper module 300, the fourth connection portion 302 disposed on the lower surface of the gripper body 310 and connected to the stage module 200 and the fifth connection portion 304 disposed on the upper surface of the gripper body 310 and connected to the manipulator 400 may receive power from the power supply unit 20 of the chamber 100, but depending on other embodiments, may receive the power of the manipulator 400, without receiving the power from the chamber 100.

Although not shown, the fifth connection portion 304 and the sixth connection portion 410 may also include the power connection portion 30 for receiving the power.

The manipulator 400 includes the manipulator 400 in various forms capable of moving the gripper module 300, and in some embodiments described below, the manipulator 400 may include an arm portion 420 and a third driving portion 430.

Depending on embodiments, the manipulator 400 may include the arm portion 420 extending from the sixth connection portion 410 and the third driving portion 430 for driving the arm portion 420 to move up and down, and the arm portion 420 may have a first end connected to the sixth connection portion 410 and a second end mounted on the body and configured to move up and down with respect to the Z-axis.

The arm portion 420 of the manipulator 400 shown in FIG. 7A is in the form of a vertical articulated robot, but it is not limited thereto, and the manipulator 400 according to present disclosure may be in various forms of a robot performing transfer of the maintenance apparatus/component parts. For example, it may be an orthogonal robot, a cylindrical robot, a spherical robot, a SCARA robot, or the like, and may also be in the form of a combination thereof.

Depending on embodiments, the arm portion 420 may be structured to be capable of replacement, and various works may be performed according to the replacement of the arm portion 420.

Although not shown in the drawings, the manipulator 400 may be a mobile manipulator 400 capable of horizontal movement in the X-Y plane. Through the horizontal movement, the object 10 of the precision work may be transported.

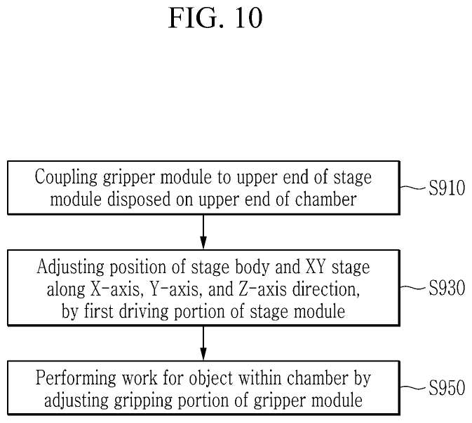

FIG. 10 is a flowchart for explaining a maintenance method using the in-chamber maintenance apparatus 1 according to some embodiments.

The method shown in FIG. 10 performs a work on the object 10 within the chamber 100, and shows a process of performing a work on the object 10 disposed within the chamber 100, by the gripper module 300 coupled to the upper end of the stage module 200.

Specifically, the method may include step S910 of coupling the gripper module 300 to the upper end of the stage module 200 disposed on an upper end of the chamber 100, step S930 of adjusting a position of the stage body 210 and the XY stage 220 of the stage module 200 along the X-axis, the Y-axis, and the Z-axis direction, and step S950 of performing a work for the object 10 within the chamber 100 by adjusting the gripping portion 324 of the gripper module 300.

At the step S910 of coupling the gripper module 300 to the upper end of the stage module 200 disposed on the upper end of the chamber 100, the third connection portion 204 located at the upper end of the XY stage 220 may be coupled to the fourth connection portion 302 located at the lower surface of the gripper body 310.

At the step S930 of adjusting the position of the stage module 200, the positions of the XY stage 220 and the stage body 210 may be precisely adjusted such that the gripping portion 324 of the gripper module 300 may be located at appropriate positions for the gripper module 300 to perform the work.

Specifically, the first driving portion 230 of the stage module 200 drives the XY stage 220 and the stage body 210 to adjust the positions of the XY stage 220 and the stage body 210, and on the X-Y plane on which the XY stage 220 is disposed, it may horizontally move the XY stage 220 in the X-axis and the Y-axis direction, or move the stage body 210 up and down along the Z-axis perpendicular to the X-axis and the Y-axis.

At the step S950 of performing the work, the gripper module 300 having moved to the appropriate position for performing the work through the adjustment of the position of the stage module 200 performs the work within the chamber 100, and may perform a work for the object 10 within the chamber 100, through movement of the gripping portion 324 capable of moving up and down and rotation with respect to the Z-axis and length adjustment of the two or more working portions 326 extending in a direction parallel to the X-Y plane.

At the step S950 of performing the work, the second sensor 330 mounted in the lower portion of the gripper body 310 may measure the interval to object disposed in the lower portion of the gripper body 310. While performing the precision work within the chamber 100, intervals to various component parts and objects within the chamber 100 as well as the object 10 positioned in the lower portion of the gripper body 310 may be identified to avoid an interference.

In an in-chamber maintenance method according to the present disclosure, positions of the gripping portion 324 and a length of the working portion 326 may be adjusted in order to perform a work on the object 10, and in particular, intervals to a plurality of objects 10 or intervals between the object 10 and other objects (e.g., other component parts) disposed in a lower portion of the gripper module 300 may be measured by using the second sensor 330, thereby minimizing interference therebetween.

While performing a work on the object 10 within the chamber 100, since the object 10 is gripped and moved by adjusting the length of the working portion 326, the object 10 may be disassembled within the chamber 100, and to the contrary, the object 10 may be assembled.

In addition, as have been described above, the structure of the gripping portion 324 and the working portion 326 of the gripper module 300 is not limited to the illustrated structure, and may be structured to be capable of performing the work such as precision assembling, maintenance, or the like, of the object 10.

The in-chamber maintenance apparatus 1 is capable of replacement to the working portion 326 having an appropriate structure for the required work during the process of maintenance, thereby performing various works.

In particular, the in-chamber maintenance apparatus 1 may precisely adjust the position of the stage module 200 through the first sensor 240 and may also precisely adjust the position of the gripping portion 324 and the length of the working portion 326 through the second sensor 330, and accordingly, the disassembling, assembling, and replacement works which necessarily require the precision operation may be facilitated.

Pre-works and post-works of works such as disassembling, assembling, and maintenance, of the object 10 disposed within the chamber 100 may be performed by the manipulator 400.

In some embodiments, the manipulator 400 may move the gripper module 300 to be mounted on the upper portion of the stage module 200, and in some embodiments, may transfer the mounted gripper module 300.

At this time, the fifth connection portion 304 disposed on an upper end of the gripper module 300 and the sixth connection portion 410 of the manipulator 400 may be coupled to each other, and the arm portion 420 of the manipulator 400 may be driven to move up and down through the third driving portion 430 of the manipulator 400. By using the manipulator 400 capable of horizontal movement, the gripper module 300 and the object 10 may be transferred, and subsequent processes may be performed.

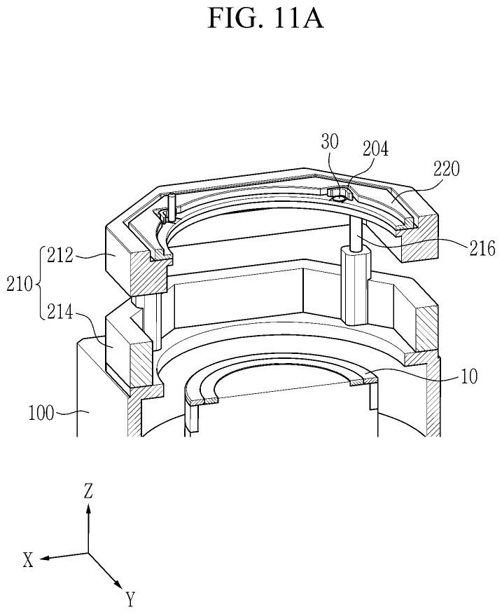

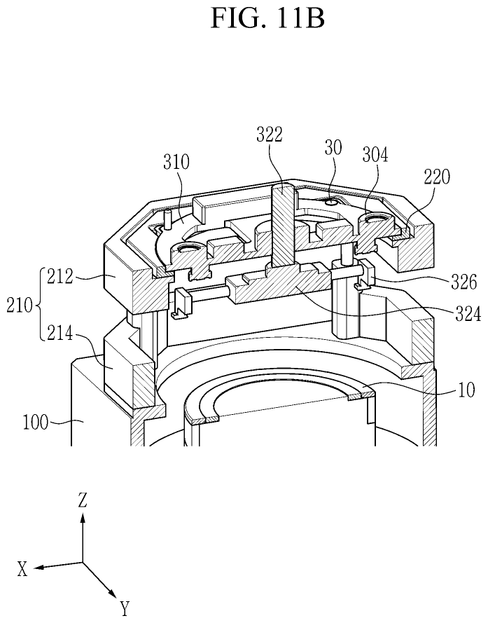

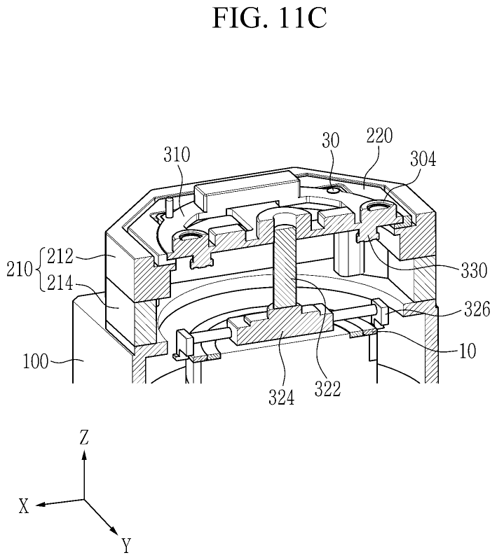

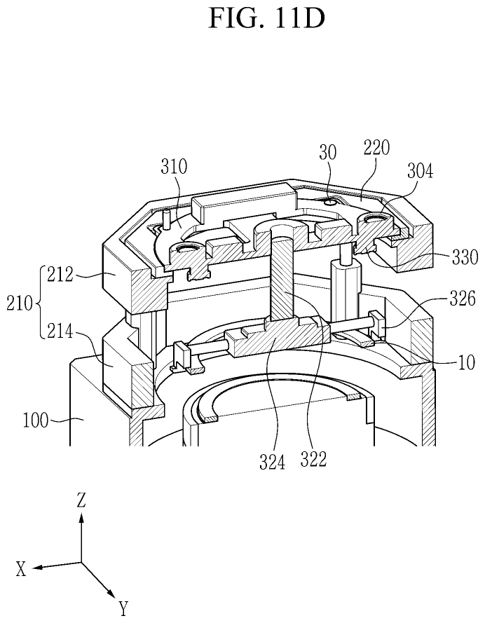

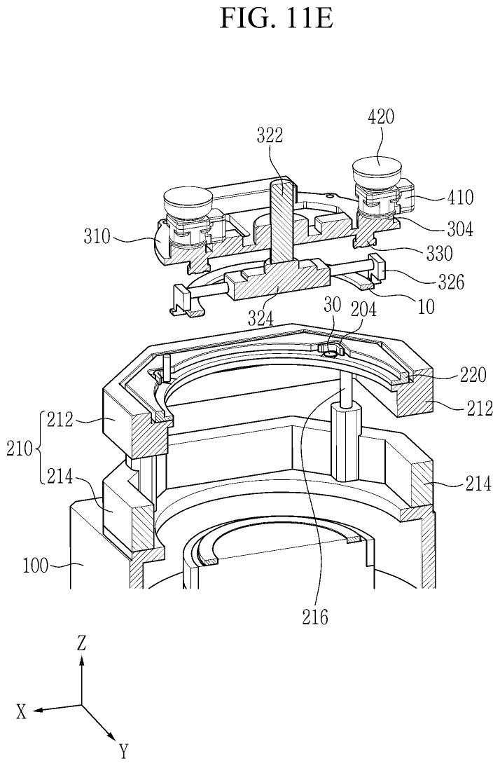

FIG. 11A to FIG. 11E are drawings showing a maintenance process using the in-chamber maintenance apparatus 1 according to some embodiments.

FIG. 11A to FIG. 11E illustrate embodiments of processes for gripping the object 10 disposed within the chamber 100 and disassembling it from the chamber 100.

FIG. 11A illustrates that the object 10 within the chamber 100 is disposed, and the stage module 200 is coupled to the upper end of the chamber 100.

In FIG. 11A, the first stage body 212 moves upward by the first drive shaft 216 of the stage module 200 and the first stage body 212 and the second stage body 214 are separated, and this represents a state before the gripper module 300 is coupled to the upper portion of the stage module 200.

Precision coupling to the gripper module 300 may be enabled through the third connection portion 204 of the stage module 200, and the power connection portion 30 receiving the power may receive the power from the power supply unit 20 of the chamber 100 to enable driving of the stage module 200.

FIG. 11B illustrates that the gripper module 300 is coupled to the upper end of the stage module 200, i.e., the XY stage 220.

Although not shown together with FIG. 11B, the sixth connection portion 410 of the manipulator 400 may be coupled to the fifth connection portion 304 of the gripper module 300, and move the gripper module 300 to the upper portion of the stage module 200, so as to be coupled to the stage module 200.

Although FIG. 11B does not illustrate the third connection portion 204 and the fourth connection portion 302, the third connection portion 204 of the stage module 200 and the fourth connection portion 302 of the gripper module 300 are in the state of being coupled to each other, and according to the power connection portion 30 included in the fourth connection portion 302, the gripper module 300 may be driven by receiving power from the power supply unit 20 of the chamber 100.

In some other embodiments, driving may be enabled by receiving the power of the manipulator 400 by the coupling to the manipulator 400.

FIG. 11C shows that, in the state that the gripper module 300 is coupled to the stage module 200 and the first stage body 212 of the stage module 200 and the gripping portion 324 of the gripper module 300 descend together and aligned, the gripping portion 324 and the working portion 326 has gripped the object 10 within the chamber 100.

Specifically, the first stage body 212 coupled to the gripper module 300 may descend and be coupled to the second stage body 214. While the first stage body 212 descends by the first driving portion 230, the second drive shaft 322 and the gripping portion 324 may also descend along the Z-axis, by the second driving portion 320 of the gripper module 300.

In the step of gripping the object 10 while the first stage body 212 and the gripping portion 324 simultaneously descend as shown in FIG. 11C, a precision operation of the stage module 200 coupled to the gripper module 300 is enabled.

That is, since the XY stage 220 is movable in the X-axis and the Y-axis direction and the stage body 210 is capable of moving up and down along the Z-axis, precision works with respect to the object 10 may be performed, by finely adjusting and fixing the position of the gripper module 300 through the precision operation of the stage module 200.

The second sensor 330 disposed in the gripper module 300 may measure a size and position of the object 10 positioned in the lower portion of the gripper body 310 and a distance to other objects or components near the object 10. That is, by measuring the interval from the gripper body 310, the gripping portion 324, and the working portion 326 to the object disposed in the lower portion of the gripper body 310 through the second sensor 330, the position of the gripping portion 324 and the length of the working portion 326 may be adjusted.

FIG. 11D illustrates that the gripped object 10 is separated from the chamber 100.

As the first stage body 212 moves upward to be separated from the second stage body 214, the object 10 is spaced apart from the assembled position within the chamber 100 by a distance by which the first stage body 212 and the second stage body 214 become spaced apart.

In the course of separating the object 10 from the chamber 100, the second sensor 330 of the gripper module 300 may measure distances to other objects and component parts adjacent to the object 10.

FIG. 11E illustrates that the gripper module 300 is separated from the stage module 200, such that the object 10 may be transferred.

FIG. 11E only illustrates the sixth connection portion 410 of the manipulator 400 coupled to the fifth connection portion 304 of the gripper module 300, and shows that the gripper module 300 is being moved by the manipulator 400.

By the third driving portion 430 of the manipulator 400, the arm portion 420 is driving to move up and down in a state of being coupled to the gripper module 300, and may separate the stage module 200 and the gripper module 300. In other embodiments, the stage module 200 and the gripper module 300 may be separated by driving the arm portion 420 only, not by the driving of the third driving portion 430.

During the process of separating the stage module 200 and the gripper module 300, the second sensor 330 may measure the distances to the adjacent objects, so as to prevent collision.

In addition, although not shown in the drawings, the object 10 gripped by the gripper module 300 and the gripper module 300 separated by the horizontal movement of the manipulator 400 may be transferred.

FIG. 11A to FIG. 11E illustrate the process of disassembling the object 10 from the chamber 100, but the work of assembling the object 10 into the chamber 100 may also be enabled.

The working portion 326 described above is structured to be capable of gripping and enabling assembling and disassembling, but the structure of the working portion 326 of the in-chamber maintenance apparatus 1 of the present disclosure is not limited to the structure capable of gripping. It may be a multi-axis driving apparatus having a structure capable of performing precision works within the chamber 100, and accordingly, may include the working portion 326 capable of performing works such as coupling, disassembling, cleaning, inspection, as well as gripping.

The in-chamber maintenance apparatus 1 according to present disclosure may include the stage module 200 capable of a precision operation of coupling to the chamber 100, and may perform precision works within the chamber 100 by coupling the gripper module 300 capable of performing various works within the chamber to the stage module 200.

In addition, the gripper module 300 may be moved manually by the worker, or moved by being connected to the manipulator 400, allowing semi-automation depending on the work.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. An in-chamber maintenance apparatus, comprising:
a stage module comprising a stage body in a chamber having a hollow interior, an XY stage on an upper surface of the stage body and movable in an X-axis and a Y-axis direction perpendicular to each other, and a first driving portion configured to drive the XY stage; and
a gripper module comprising a gripper body coupled to an upper surface of the XY stage, a gripping portion supported by the gripper body and configured to move up and down and rotate with respect to a Z-axis perpendicular to the X-axis and the Y-axis to be inserted into the hollow interior, and a second driving portion configured to drive the gripping portion.

2. The in-chamber maintenance apparatus of claim 1, wherein the first driving portion is configured to horizontally move the XY stage in the X-axis and the Y-axis direction on an X-Y plane on which the XY stage is disposed, and to move the stage body up and down along the Z-axis.

3. The in-chamber maintenance apparatus of claim 2, wherein:
the stage module includes a first drive shaft extending parallel to the Z-axis, on a circumference where a lower end of a first stage body and an upper end of a second stage body meet; and
the first stage body is configured to move up and down by the first drive shaft, so as to be separated from or coupled to the second stage body.

4. The in-chamber maintenance apparatus of claim 1, wherein the stage module comprises a first sensor configured to measure a position of the stage module.

5. The in-chamber maintenance apparatus of claim 1, wherein the gripper module comprises a second drive shaft extending in the Z-axis direction and connecting the gripper body and the gripping portion.

6. The in-chamber maintenance apparatus of claim 5, wherein the second drive shaft extends in the Z-axis to support the gripping portion, and is configured to be driven to move up and down and rotated with respect to the Z-axis.

7. The in-chamber maintenance apparatus of claim 1, wherein the gripping portion comprises first and second working portions extending in a direction parallel to an X-Y plane on which the XY stage is disposed.

8. The in-chamber maintenance apparatus of claim 7, wherein the first and second working portions have an adjustable length in the extending direction such that a spacing between the first and second working portions can be adjusted.

9. The in-chamber maintenance apparatus of claim 1, wherein the gripper module includes a second sensor on a lower surface of the gripper body.

10. The in-chamber maintenance apparatus of claim 9, wherein the second sensor is configured to measure an interval or distance between the gripper body and an object below the gripper body.

11. The in-chamber maintenance apparatus of claim 9, wherein the second sensor is at least one of a vision sensor and a displacement sensor.

12. An in-chamber maintenance apparatus, comprising:
a stage module comprising a stage body in a chamber having an opening and having a hollow interior, an XY stage on an upper surface of the stage body and movable in an X-axis and a Y-axis direction perpendicular to each other, and a first driving portion configured to drive the XY stage;
a gripper module comprising a gripper body coupled to an upper surface of the XY stage, a gripping portion supported by the gripper body and configured to move up and down and rotate with respect to a Z-axis perpendicular to the X-axis and the Y-axis and to be received in the hollow interior, and a second driving portion configured to drive the gripping portion; and
a manipulator coupled to an upper surface of the gripper module and configured to move the gripper module.

13. The in-chamber maintenance apparatus of claim 12, wherein:
the stage body includes a second connection portion at a lower end thereof coupled to a first connection portion of an upper portion of the chamber;
the XY stage includes a third connection portion at an upper end thereof;
the gripper body includes a fourth connection portion at a lower end thereof coupled to the third connection portion; and
the chamber, the second connection portion, and the third connection portion comprise a power connection portion configured to supply power from a power supply unit of the chamber.

14. The in-chamber maintenance apparatus of claim 13, wherein the third connection portion comprises:
a first coupling portion coupled to the gripper module; and
a second coupling portion configured to guide coupling of the first coupling portion.

15. The in-chamber maintenance apparatus of claim 13, wherein the manipulator comprises:
a sixth connection portion coupled to a fifth connection portion on an upper surface of the gripper body;
an arm portion connected to the sixth connection portion, and configured to move up and down with respect to the Z-axis; and
a third driving portion configured to move the arm portion up and down.

16. The in-chamber maintenance apparatus of claim 15, wherein the fourth connection portion and the fifth connection portion of the gripper module comprise the power connection portion configured to supply power from the chamber power supply unit or the manipulator.

17. The in-chamber maintenance apparatus of claim 12, wherein the manipulator is horizontally movable.

18. The in-chamber maintenance apparatus of claim 12, wherein the first driving portion is configured to horizontally move the XY stage in the X-axis and the Y-axis direction on an X-Y plane on which the XY stage is disposed, and to move the stage body up and down along the Z-axis.

19. The in-chamber maintenance apparatus of claim 18, wherein:
the stage module includes a first drive shaft extending parallel to the Z-axis, on a circumference where a lower end of a first stage body and an upper end of a second stage body meet; and
the first stage body is configured to move up and down by the first drive shaft, so as to be separated from or coupled to the second stage body.

20. The in-chamber maintenance apparatus of claim 12, wherein the stage module comprises a first sensor configured to measure a position of the stage module.
